(19) United States
(12) Patent Application Publication
(10) Pub. No.: US 2016/0040623 A1
(43) Pub. Date: Feb. 11, 2016

(54) PISTON MACHINE AND METHOD FOR THE OPERATION THEREOF

(71) Applicant: Alfred SPIESBERGER, (US)

(72) Inventor: Alfred SPIESBERGER, Buchkirchen (AT)

(21) Appl. No.: 14/782,854

(22) PCT Filed: Apr. 16, 2014
(86) PCT No.: PCT/AT2014/050094

§ 371 Date: Oct. 7, 2015

(30) Foreign Application Priority Data
Apr. 16, 2013 (AT) A 50261/2013

(51) Int. Cl. F02G 1/044; F02G 1/055

(52) U.S. Cl. CPC F02G 1/044; F02G 1/055

(57) ABSTRACT

A piston machine (1) for converting heat into work or for heating and cooling by the application of work, having at least one chamber arrangement (8), which comprises at least two chambers (2, 3, 4) connected by at least one connecting duct (9, 10), wherein at least two of the chambers (2, 4) are substantially thermally insulated against one another, and having pistons (5, 6, 7) which are impermeable to a working medium and are movably arranged in the respective chambers (2, 3, 4) to vary a partial working volume bounded by the chamber (2, 3, 4) and the piston (5, 6, 7), wherein at least one of the chambers (2, 4) comprises thermal transfer surfaces (34, 45) to increase the surface area thereof, wherein the pistons (5, 6, 7) or elements connected therewith, are connected to actuating elements for defining motion profiles for each of the pistons (5, 6, 7), and wherein the actuating elements are designed to define at least two different motion profiles for the pistons (5, 6, 7) in the chamber arrangement (8).

The invention relates to a piston machine and a method for the operation thereof for converting heat into work or for heating or cooling by the application of work, having at least one chamber arrangement, which comprises at least two chambers connected by at least one connecting duct, wherein at least two of the chambers are substantially thermally insulated against one another, and having pistons which are impermeable to a working medium and are movably arranged in their respective chambers to vary a partial working volume bounded by the chamber and the piston, wherein at least one of the chambers comprises thermal transfer surfaces to increase the surface area thereof, and wherein the pistons, or elements connected therewith, are connected to actuating elements for defining motion profiles for each of the pistons.

Thermal transfer surfaces are to be understood to be surface areas of the chamber surface, which are heated or cooled by specific technical measures, to absorb or give off heat for thermodynamic purposes. In addition, if the thermal transfer surfaces cause a significant increase in the internal surface of the chamber as compared to the original shape of the chamber, that is as compared to the simple geometric elements underlying the chamber, such as a cylinder having a plane or dome-shaped base area and/or deck area or in case of doubt, if thermal transfer surfaces are present in the chamber and the internal chamber surface of the chamber expanded to the largest partial working volume which is operatively obtained, exceeds the surface of a comparable cylinder identical in terms of volume and having a circular, planar base and deck area as well as at the diameter-to-height ratio of 1 by more than 1.5 times, then the chamber comprises thermal transfer surfaces to increase its surface.

The most common and best-known piston machines for converting heat into work are motor vehicle engines, such as the Diesel engine or Otto engine. The thermodynamic cycle (in short, “cycle”) underlying these machines is the Diesel cycle or the Otto cycle or, in general, the Seiliger cycle. The preferred model cycle of the present invention, that is the thermodynamic cycle which is preferably approximated by the present invention, is the Carnot cycle known per se. It describes the physical maximum of converting heat into mechanical energy with given heat sources and heat sinks. Consequently, the machines reproducing the previously cited cycles, as well as the Joul, Ericsen or Clausius-Rankine cycles known in connection with turbo machines, show an inherently suboptimal efficiency. One exception to this is represented by Stirling machines, whose model cycle is the Stirling cycle, since here theoretically the same efficiency might be obtained as in the Carnot cycle, by means of using a regenerator assumed to be functioning perfectly. However, in many cases this option has turned out to be disadvantageous, because during a cycle play or cycle pass or a cycle run of a thermodynamic cycle, which is the once-through sequence of the thermodynamic changes of state characterizing the thermodynamic cycle together with any intermediate processing steps or operations, the regenerator will never be able to give off again the entire heat stored and itself causes a large dead space or clearance volume,

The DE 27 36 472 A1 shows a valve-less piston machine having two cylinders and pistons arranged therein, whose cranks are offset such that the movement of the piston has a fixed phase shift of 90°. To improve the thermal transfer in the cylinders, of which one comprises a heating space and the other a cold space, onto the working medium (preferably helium) or vice versa, the pistons and the cylinders are provided with complementary surfaces projecting into the working chamber. The cylinders are connected by means of a heat exchanger extending in a curved manner between the cylinders, which comprises surfaces for storing heat and thus is a regenerator typical of Stirling machines.

The thermal engine known from DE 103 19 806 B4 likewise functions according to the Stirling principle. An expansion cylinder having a heater forms an expansion chamber and a compression cylinder having a cooler forms a compression chamber.

The two working chambers comprise a plurality of conical tubes arranged in parallel, which are engaged by corresponding piston pins of the associated pistons and fill these. The working chambers are connected via separate transfer passages, which are used as heat exchanger surfaces and are provided with check valves, and here, too, the two pistons are moved in a manner offset by 90 crank angle degrees.

In the machines described in DE 27 36 472 A1 and DE 103 19 806 B4 it is disadvantageous that both pistons follow the same sequence of motions, that is essentially a sinus movement, which is deferred only by a phase shift of 90° (corresponding to a quarter working cycle) between the pistons. Such a sequence, however, may at best approximate an ideal Stirling cycle, so that simply because of this a reduced efficiency is obtained.

In connection with Stirling machines of a basically different construction, pistons having different motion profiles have been shown already, however, at least one piston being a regenerator, which can never be impermeable for a working medium, since the working medium invariably can or must pass through or pass by. Examples of such machines can be found in the DE 195 28 103 A1, DE 198 54 839 C1 and CH 701 391 B1. Due to the totally different construction and the different mode of operation, however, none of these machines includes thermal transfer surfaces in the chambers. For this reason and also for the reason that all of the machines shown have a considerable clearance volume due to the regenerators, none of these machines is suitable to simulate the Carnot cycle.

Accordingly, it is the object of the present invention to propose a piston machine that works according to an approximately ideal Carnot cycle by reducing any clearance volumes as far as possible, obtains in certain chambers an optimum heat exchange between the chamber walls and the working medium and, at the same time, makes possible piston movements adapted to the ideal changes of state according to the Carnot cycle.

In a piston machine of the above cited type, said object is achieved in that the actuating elements are designed to define at least two different motion profiles of the pistons of the chamber arrangement. In this connection, it is of minor importance by which actuating elements the motion profiles, that is the time sequences of the piston movements are defined. In particular, what is to be expressed in particular by the term motion profile is that different motion profiles relate to different motion requirements concerning their time characteristics, and that for example a basically different time sequence of the piston movements is obtained. For example, different motion profiles which are only deferred or offset in time or have different amplitudes are not different within the meaning of the invention, that is to say different movements are not synonymous with different motion profiles. In addition, it is quite significant that—as pointed out above—the pistons for the working medium allocated to said actuating elements do not allow the working medium to pass through them and make a tight contact with the chamber walls, since only then clearance volumes reducing the efficiency can be avoided to the greatest possible extent, which only makes the different motion profiles according to the invention appear to be useful for solving the object. In contrast thereto, machines having a permeable piston or a piston which is not pressure-tight pursue a totally different aim, that is the implementation of the Stirling cycle, with the respective pistons usually working as regenerators. The present piston machines do without a regenerator or are constructed in a manner devoid of regenerators. In particular, the connecting ducts have a smooth surface and a small volume as compared to the expanded chambers, with their cross-sections preferably still being sufficiently large to obtain an approximately resistance-less flow-through. In addition, with respect to the size as compared to the expanded chambers, in particular as compared to a chamber comprising thermal transfer surfaces to increase its surface, the connecting ducts have a small internal surface, over which the working medium can flow easily. Thus, the connecting ducts are characterized by a free flow and an essentially thermally neutral behavior with regard to the working medium. Both the pistons and the connecting ducts between the chambers are devoid of a regenerator, through which a working medium flows, thereby avoiding clearance volumes which otherwise will inevitably occur.

Accordingly, in a method according to the above cited type to operate such a piston machine, the object posed is solved in that in the course of a run of the approximated Carnot cycle performed in the chamber arrangement, at least one, preferably each of the pistons involved in the run, essentially stands still at least once with respect to the run during a dead phase, wherein a partial working volume limited by the piston and by the chamber allocated thereto is essentially zero during the dead phase. The dead phase refers to a time period of a certain (finite) duration and not to a point in time, such as for instance the dead center typical in pistons.

Above and below herein, the term partial working volume refers to the volume present in a chamber at a certain point in time, that is the volume contained in a chamber at a certain time, i. e. limited by the chamber and the piston allocated thereto. The term working volume in each case refers to the sum of the volumes of those partial working volumes and those volumes of connecting ducts, which are all interconnected, that is to say not sealed off against each other, wherein the working medium contained in the working volume and the working medium contained in the sum of volumes are identical. This also means that at least a certain partial working volume is allocated to the working volume and, vice versa, a certain working volume is allocated to the partial working volume. In other words and considering the relatively small volumes of the connecting ducts, it may be said that the working volume is essentially the sum of the contiguous partial working volumes allocated to it. In addition, it follows therefrom that a partial working volume of a chamber is always smaller (theoretically at best equal, if there were a partial working volume exactly allocated to the working volume and the associated volumes of the connecting duct were to be zero) than the working volume allocated thereto. Therefore, in order to increase the efficiency, it is possible that, in a chamber arrangement having at least four chambers, two working volumes or, in a chamber arrangement having even more chambers, even more working volumes separated from one another are contained in the chamber arrangement, wherein the pistons of the chamber arrangement are able to control different working mediums during different periods of time; in this connection, different working mediums do not necessarily have to refer to different types of working medium, but means that the different working mediums are contained in different working volumes. Therefore, several cycles, which in the present case each have a working medium of their own, may be designed in parallel in the chamber arrangement. If the cycles are identical in type, for example, two approximated Carnot cycles, it can also be said that the approximated Carnot cycle is performed twice in the chamber arrangement. The cycles performed in parallel in the chamber arrangement, however, may also be different in kind, for example, an approximated Carnot cycle and an approximated Stirling cycle.

During the operation of the piston machine according to the invention, the state points of a cycle performed by means of said machine may vary from run to run, the type of cycle not necessarily having to change. This means that a run of a cycle, for example, in the p-V diagram, may look different than another run of the same cycle. In particular in the case of actuating elements for the generation of motion profiles, it is also possible that the type of cycle carried out by the piston machine changes during the operation of the piston machine according to the invention, for instance, an approximated Stirling cycle which is initially performed in the chamber arrangement may later be transferred into a Carnot cycle.

In addition, it is possible that during one run of a cycle or during said run period not all of the pistons of the chamber arrangement come into contact with the working medium involved in the run, which working medium may be contained together with other independent working mediums in the chamber arrangement. Even if the chamber arrangement comprises only a single working medium or if a cycle is performed in the chamber arrangement with only a single working medium, not all of the pistons of the chamber arrangement necessarily have to be involved in one and the same run of the cycle, because some pistons of the chamber arrangement may be stationary throughout the entire run, to only receive heat from their heat source, whereby only a group of pistons involved in this one run may be present in the chamber arrangement.

In any case, above and below herein, it is to be understood that each run of a cycle performed is unique, even if two runs of a cycle appear to be identical on the basis of their p-V diagrams.

If at least two of the chambers comprise the thermal transfer surfaces to increase their surfaces, an efficient and fast heat exchange with the chamber surroundings can be achieved advantageously both during heat adsorption and during heat delivery.

To obtain an almost ideal change of state—in particular with respect to the isentropic state of change aimed at in the Carnot cycle—in one of the other chambers, it is of advantage if at least one of the motion profiles defined by the actuating elements has at least one dead phase during which one of the pistons connected to the respective actuating element is essentially stationary.

Furthermore, to avoid any clearance volumes, it is favorable in such motion profiles if a partial working volume limited by the piston located in the dead phase of its motion profile and by the chamber allocated thereto is essentially zero. The temporarily stationary piston not only tightly seals off—as pointed out in the above—against the chamber allocated thereto, but also completely fills the same, so that any working medium is removed from the chamber. Of course, with respect to one of the other pistons, whose motion profile likewise has a dead phase, a partial working volume deviating from zero during the dead phase can be provided.

To take into account the asymmetry with respect to the time course of the working volume or the partial working volumes inherent to the Carnot-cycle and the best possible factual practicability of the changes of state, for example, the relative high rate of expansion or compression necessary for isentropic changes of state or the relative low rate of expansion or compression necessary for isothermal changes of state or the relative short period of time for a possible adiabatic change of chambers of the working medium, it has turned out to be advantageous if at least one of the motion profiles has different time intervals between a dead center and the succeeding dead phase, on the one hand, and between the dead phase and the succeeding dead center, on the other hand, in particular is directional. In the clockwise Carnot cycle illustrated below, the different time intervals can be understood in particular by means of the larger volume change in the isentropic expansion as compared to the isentropic compression, which results in that the isentropic expansion lasts longer than the isentropic compression at the same piston speed and with the same piston cross-sectional surface of the respective piston. Furthermore, concerning the isothermal changes of state, in order to be able to perform them as accurate as possible, it is of advantage to have them run slowly as compared to the changing of the working medium into the other chamber—this intermediate operation is performed profitably faster, since time-saving and rather adiabatic.

If the actuating elements of the chamber arrangement or the motion profiles defined by them are matched to one another in such a way that when looking at a single working volume, which essentially is the sum of the interconnected partial working volumes allocated thereto, in operation at least one of the chambers and at most two of the chambers has/have a partial working volume which is essentially different from zero, on the one hand, a clear spatial separation of the changes of state can preferably be obtained and, on the other hand, changing the working medium from the one chamber into the other chamber can reasonably be managed, wherein, depending on the number of available chambers of the chamber arrangement, it is favorable to perform a change of state of the working medium—in particular in the case of two chambers—or perform no change of state—in particular in the case of more than two chambers—at the same time. Thus, the working volume, i. e. also the working medium is always subjected to a change of state or a change of chamber in the chamber(s) provided for this, which increases the efficiency of the piston machine. This applies irrespective of whether more than one working medium is advanced in a chamber arrangement having four or more chambers. In these cases, too, in operation at least one of the chambers and at most two of the chambers have a share in one and the same working volume which is essentially other than zero. Consequently, any (partial) working volumes possibly enclosed by other chambers of the chamber arrangement and tightly separated from the relevant working volume at any time during a cycle run are not excluded thereby. Coordinating the actuating elements may be effected by a coordination means, e. g. a joint axis or a joint or communicating programmable control (s).

It is favorable to have the at least one connecting duct devoid of valves, so as to avoid any losses reducing the efficiency during the transport of the working medium between the chambers. Thus, the resistance produced by a valve to the working medium, which resistance, among other things, is due to the force necessary to open the valve, is being avoided. In addition, connecting ducts devoid of valves have the advantage of having simpler construction and a higher degree of reliability.

Another possibility, which is known in connection with conceptually different machines, to obtain the necessary thermal transfer surfaces is that the thermal transfer surfaces of one of the chambers are formed by the inner wall of the respective chamber and the piston arranged in the corresponding chamber comprises a surface complementary to the thermal transfer surfaces of the respective chamber, which surface preferably is also designed to transfer heat. In the case of such a chamber geometry, with respect to the thermal transfer in a relatively small space a relatively large piston cross-section can be simulated, wherein in the case of an identical heat transfer the piston motion related to the simulated piston cross-section, i. e. the actual piston surface, seems to be slowed down. An advantageous surface-to-volume ratio is achieved thereby, favoring a fast heat exchange or a fast balance of any temperature differences in the working medium.

In addition, it can be achieved that the thermal transfer surfaces of one of the chambers are designed with a garland-like thermal transfer element, which is arranged in the respective chamber or between the respective chamber and its associated piston. Such a garland-like thermal transfer element is expanded or compressed during a piston motion and can achieve any increase in the surface, depending on the number of layers and/or windings. In the case of suitable dimensions, i. e. if the cross-section or the base of the completely compressed (“folded”) thermal transfer element essentially corresponds to the piston cross-section, the partial working volume of the corresponding chamber can advantageously be reduced to zero, in particular if another element complementary to the folded thermal transfer element is provided within the corresponding chamber or on the piston allocated to it. Another advantage of such a thermal transfer element is the simple and good heat exchange with the chamber during the dead phase, since the path necessary for the transfer is significantly shortened in the case of stacked layers. Of course, it is within the meaning of the invention to provide several thermal transfer surfaces in this manner, i. e. with garland-like thermal transfer elements, and also several such thermal transfer elements can form the thermal transfer surfaces or be arranged in a single chamber.

Another option of how to compensate for the above cited asymmetry of the Carnot cycle by way of construction lies in that at least two of the chambers have different capacities and working temperatures, wherein in particular the one chamber having a relatively low working temperature has a larger capacity than the other chamber having a relatively high working temperature. The capacity, in particular, may be adapted by different chamber cross-sections.

In addition, it is favorable if the pistons have an approximately identical stroke capacity in their associated chamber. This allows a good use of space, since typically at least one external dimension of the piston machine according to the invention conforms to the chamber having the largest stroke capacity anyway. Furthermore, this favors an advantageous identical parts concept of the components used.

Particularly flexible and accurately configurable motion profiles may be obtained, if at least one of the actuating elements comprises a curve element, with which the piston allocated to the actuating element and/or elements connected to the piston is/are connected via a roll element. In this connection, the curve element, which may be formed by a disk cam, can exactly imitate the desired sequence of motions by means of its shape to be produced in any desired way, and at the same time can function as a flywheel.

To avoid losses during the reversal of the direction of movement of the piston, that is between the pushing and pulling motions, the roll element can be composed of least two profile rolls, wherein the at least two profile rolls due to their arrangement do not change their directions of rotation when going through a thermodynamic cycle performed in the chamber arrangement (8), with unchanged direction of rotation of the curve element allocated thereto. In particular, with regard to the curve element, one of the profile rolls can be arranged radially inside and the other profile roll can be arranged radially outside opposite thereto, so that during pushing motions power is transmitted via the radially interior profile roll and during pulling motions power is transmitted via the radially exterior profile roll.

To minimize undesired and thus loss-causing forces or torques, it has been found to be favorable if a center distance ascertained in the direction of stroke between a guide roll of one of the roll elements and one of the profile rolls of the same roll element is small in comparison to a distance ascertained in the direction of stroke between the axis of rotation of the profile roll and the piston allocated to the roll element, preferably about zero, so that a motion, which is as frictionless as possible, of the piston allocated to the roll element is obtained in its chamber. Thus, in particular lateral forces causing a high friction on the piston can be prevented, which otherwise would reduce the efficiency of the piston machine.

A mechanically even less limited power transmission from one or to one piston can be achieved, if at least one of the actuating elements comprises a motor-generator unit and the piston(s) allocated to the actuating element or elements connected thereto is/are connected to the rotor of the motor-generator unit. The motor-generator unit can, of course, comprise a motor and a separate generator, whose rotors are mechanically coupled. Any server amplifier and/or programmable control may likewise belong to the motor-generator unit.

The motion profiles realized by such actuating elements may even be adapted during operation, if at least one of the actuating elements is suited to produce variable motion profiles, in particular is freely programmable. Thus, in particular, a different quantity of heat or work and the other changing boundary conditions for operating the piston machine according to the invention can be taken into consideration.

Since the forces exerted by or upon the piston(s) are, by nature, different also in terms of the amount, it is favorable if a gear transmission, in particular a pantograph-like coupled gear, or a ball screw is interconnected between at least one of the actuating elements and the piston allocated thereto. For example, also favorable motions of the rotors of electromagnetic actuating elements can be obtained, without having to dispense with the processing speed which is optimal for the change of state.

In particular, to be able to perform isentropic changes of state as accurately as possible in the case of two chambers having the thermal transfer surfaces, and despite the conditions of an adiabatic change of state of the working medium, which conditions are limited in the chambers having the thermal transfer surfaces, it is of advantage that the chamber arrangement comprises three chambers, wherein the middle chamber is connected to the two other chambers by means of the at least one connecting duct. In the case of three and more than three chambers, the term “middle chamber” is to be understood to the effect that it refers to those chambers in which mainly approximately isentropic changes of state occur. The other chambers, that is to say those chambers in which mainly approximately isothermal changes of state occur, are connected to the middle chamber(s).

In the chamber arrangement, in particular with respect to the amount of heat transmitted during a change of state between the chamber and the working medium, to be able to perform different types of changes of state, in particular in the case of approximately isothermal changes of state occurring at different temperatures, on the one hand, and the approximately isentropic change of state, on the other hand, it is of advantage if due to its shape the middle chamber has a larger distance in terms of the arithmetic mean, in particular a distance which is at least 1.5 times larger, between a volume element, which is assumed to be as small as desired, of its partial working volume extended to the reference volume and its inner chamber surface limiting the partial working volume, than at least one of the at least two chambers connected by at least one connecting duct, wherein the reference volume is constituted by the smaller volume of the two maximum partial working volumes obtained during operation by the chambers compared to one another, and the inner chamber surface limiting the partial working volume, of course, also comprises the possible thermal transfer surfaces to increase the (internal) surface of the chamber, and comprises the surface areas adjacent the partial working volume of the piston arranged in the chamber, and wherein the distance is defined to be the length of the shortest connecting line.

To avoid any distortion of the isentropic changes of state in conjunction with the heat exchange and a reduction of the efficiency of the piston machine resulting from this, the middle chamber(s) is/are conveniently devoid of any thermal transfer surfaces to increase its surface and/or is thermally insulated at least against one of the other chambers, in particular at least the chamber having a relatively high working temperature. Therefore, it is favorable if the middle chamber(s) has/have a smaller internal surface than a chamber having the thermal transfer surfaces to increase their surfaces, in particular than that chamber having a relatively low working temperature.

By virtue of mechanical limitations, for example, at a given piston speed a relatively even faster change of volume can be obtained, if the middle chamber has a larger capacity than one of the chambers having a relatively high working temperature. Moreover, thereby the maximum working volume, which is necessary in one of the isentropic changes of state of the working medium, can be made available in a suitable manner.

To control the amounts of heat, which are exchanged between the chambers and the working medium during the changes of state performed in the chambers of the piston machine according to the invention and which are decisive for the different types of changes of state, preferably at least one of the at least two chambers connected by at least one connecting duct, with which the working medium is to exchange a relatively large amount of heat, preferably during an approximately isothermal change of state, can have a large internal surface or it is favorable if as much working medium as possible is available very close to its internal chamber surface, which preferably can be achieved in that opposing surface areas of the internal chamber surface have a smaller distance. Another aspect favoring the exchange of a relatively large amount of heat is to choose the piston cross-section and the piston stroke as small as possible—or vice versa, also areas of the internal chamber surface might have a markedly serrated shape, or a dilatable or compressible garland-shaped thermal transfer element having thermal transfer surfaces might be arranged in the chamber.

The chamber, preferably the middle chamber, with which the working medium is to exchange a relatively small amount of heat preferably during an approximately isentropic change of state, can preferably comprise a small internal surface, or it is favorable for this chamber, if as much working medium as possible is available far away from its internal chamber surface, which can preferably be thermally isolated against the external surroundings, which, for example can be achieved by means of surface areas of the chamber surface, which are at a large distance opposite to one another. The above-mentioned chamber may preferably have a piston diameter which is equal to its piston stroke. In addition, it is favorable if the interior of the chamber is predominantly designed with a smooth surface, wherein it would be additionally convenient if the internal chamber surface had only some or no bulgings or indentations.

To be able to perform, in particular, an approximated isothermal change of state of the working medium in the chamber having the thermal transfer surfaces to increase its (internal) surface and to achieve the good heat exchange of the chamber with the working medium by making its internal surface as large as possible and/or positioning the working medium as closely as possible to its internal surface, it is advantageous to design the profile of the thermal transfer surfaces produced by a cross-section with multiple serrations to increase the (internal) surface of the chamber.

By virtue of the different objects with respect to the heat exchange with the working medium and to avoid a heat flow between the chambers, it is of advantage if one of two chambers having the thermal transfer surfaces is made of a material having a relatively high thermal capacity, in particular copper or aluminum or alloys thereof, and the middle chamber is made of a material with poor thermal conductivity, in particular, ceramics or glass ceramics.

If one of the chamber arrangements comprises a gas having a high specific gas constant as a working medium, in particular helium, the flow losses during the transport of gas between the cylinders can be reduced, since the moved mass may remain small. In addition, the dimensions of the chamber arrangement may be reduced, with the energy converted by the chamber arrangement staying the same. Of course, it is especially advantageous if several or even all of the chamber arrangements have a corresponding working medium, however, it is also possible to use different working mediums. On the other hand, using air as a working medium also entails advantages; for example—depending on the work pressure—the tightness of the chamber arrangement is less problematic, since the emission of air into the surroundings is uncritical in general.

The forces to be transmitted between one of the pistons and the actuating element allocated thereto can be further optimized and the losses associated therewith can be reduced, if at least one of the pistons is connected to a spring element, in particular to a magnetic, mechanic or gaseous spring element to support the actuating element allocated to the piston. In particular, any losses which are caused by the actuating elements can be reduced, in particular the losses caused by electromagnetically working actuating elements, while they specify dead phases.

The forces, which during the necessary linear movements of the pistons are transmitted e. g. onto a base or a support of the piston machine, will naturally result in losses, e.g. due to unavoidable absorptions, which might be reduced, if at least one other chamber arrangement, which is essentially identical with the chamber arrangement, (said at least one other chamber arrangement) having pistons is provided, wherein the inertia effects of the pistons including the elements of all chamber arrangements connected therewith essentially cancel each other out. The essential mass inertia effects, in particular, are the mass inertia forces of the pistons and those of the elements connected to the pistons, wherein also moments of inertia, for example of the actuating elements, are included.

It is further advantageous if at least two different pistons belonging to different chamber arrangements are connected to a common actuating element. The pistons connected to a common actuating elements are preferably related, that is to say the changes of volume obtained by them belong to identical changes of state in the different chamber arrangements. The common actuating element, for example, can perform a symmetric motion of the pistons of different chamber arrangements, wherein synchronizing the movements is guaranteed in a natural manner by means of the unit of the actuating element.

In the above cited method of operating a piston machine of the above-given type, it is especially favorable if a working volume of the chamber arrangement, which essentially is the sum of the interconnected partial working volumes allocated thereto, is essentially distributed over the allocated partial working volumes of one or two chambers at any time. With such a distribution, that is if at a certain time or at any time during a run of the cycle any possible third or other chambers of the same chamber arrangement have a partial working volume of essentially zero, an almost ideal and thus almost unaltered change of state of the working medium or a change of chambers of the working medium can be obtained, which is desirable to obtain the optimum efficiency.

To obtain a homogeneous temperature within the entire volume of the working medium, it is favorable if with respect to the run the duration of the dead phase of one of the pistons or in the chamber allocated to the piston is nearly equal to or larger than the duration of the approximately isothermal change of state allocated to the run and at least partially overlapping with said dead phase, in one of the other chambers involved in the run. In such a sequence, the isothermal change of state preferably fully takes place in a single chamber of the chamber arrangement.

If within the chamber, with respect to the run, each of the dead phases involved therein lasts at least 15%, in particular at least 25% of the time of the run, this may result in a particularly good and uniform distribution of temperature in the respective chamber or the piston allocated thereto during one of the dead phases, whereby e.g. the change of state of the working medium succeeding its phase can follow particularly well the desired target change of state.

It is advantageous if in one of the other chambers involved in the run of a cycle performed in the chamber arrangement, a change of state of the working medium can be performed undisturbed, and in addition it corresponds to a clear allocation of one chamber to few directly succeeding changes of state, if each of the pistons involved in the run in one of the chambers allocated to them and having a direct connection to exactly another one of the chambers involved therein, has exactly one dead phase allocated to the run with respect to the run. For the same reasons, it is advantageous if each of the pistons involved in the run in one of the chambers allocated to them and having a direct connection to exactly two more of the chambers involved therein, with a working medium involved therein flowing unidirectionally through the direct connection, has exactly one dead phase allocated to the run with respect to the run.

Vice versa, several identical changes of state can also be performed in the same chamber, in particular if they do not require heat exchange, so that each of the pistons involved in the run in one of the chambers allocated to them and having a direct connection to exactly two more of the chambers involved therein, with a working medium involved therein flowing bidirectionally through the direct connection, has two dead phases allocated to the run with respect to the run.

A particularly good approximation to the model cycle can be obtained if the entire duration of all of the dead phases allocated to the run, of a piston, which contributes to at least one of the approximately isentropic changes of state involved in the run, is longer than the dead phase of a piston, which contributes to one of the approximately isothermal changes of state involved in the run. Accordingly, it is favorable if in total the two approximately isentropic changes of state of the run are performed faster, in particular at least two times faster, than the total of the two approximately isothermal changes of state allocated to the run. This can provide sufficient time for the heat exchange during the isothermal change of state, while a change of entropy is counterbalanced during the short time during the faster isentropic change of state.

In addition, in the present method, the working volume can be adapted during the operation of the substantial piston machine, if at least one thermodynamic state quantity of one of the working mediums present in the chamber arrangement is determined and the time course of one of the working volumes of at least one of the chamber arrangements, which essentially is the sum of the interconnected partial working volumes allocated thereto, is varied as a function of the at least one determined state quantity, whereby the approximated Carnot cycle is modified and better adapted to variable boundary conditions, such as the amount of energy available. This means that successive runs of the cycle may be different with respect to their state points.

Instead of directly ascertaining a thermodynamic state quantity or additionally, at least one measured quantity, in particular the position of one of the pistons, the force acting upon one of the pistons by the working medium or the upper or lower cycle temperature available for the thermodynamic cycle can be determined, which measured quantity is interrelated with a thermodynamic state quantity of one of the working mediums present in the chamber arrangement, and the time course of one of the working volumes of at least one of the chamber arrangements, which essentially is the sum of the interconnected partial working volumes allocated thereto, can be varied as a function of the at least one determined state quantity. In this connection, it is irrelevant whether a thermodynamic state quantity is indeed derived from the determined measured quantity and/or still other measured quantities or specifications would be required therefore.

The invention will be described by way of especially preferred embodiments, however, not intended to be limited thereto, and by reference to the drawing. The drawing shows the following in detail:

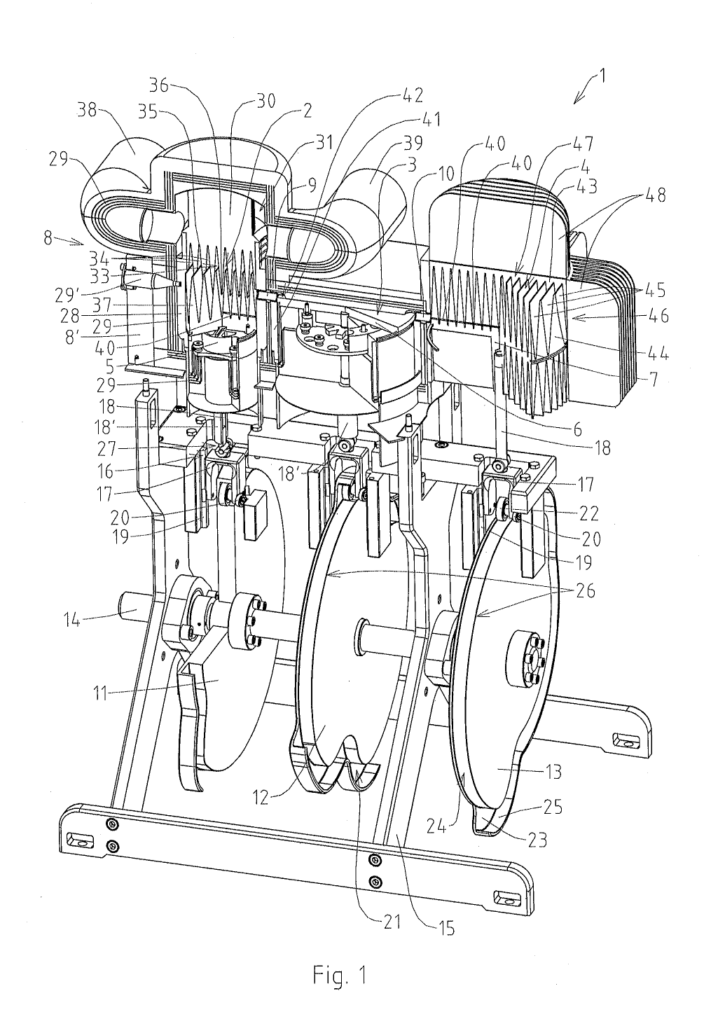

FIG. 1 shows a diagram of the piston machine according to the invention, comprising three pistons which are each connected to a disk cam;

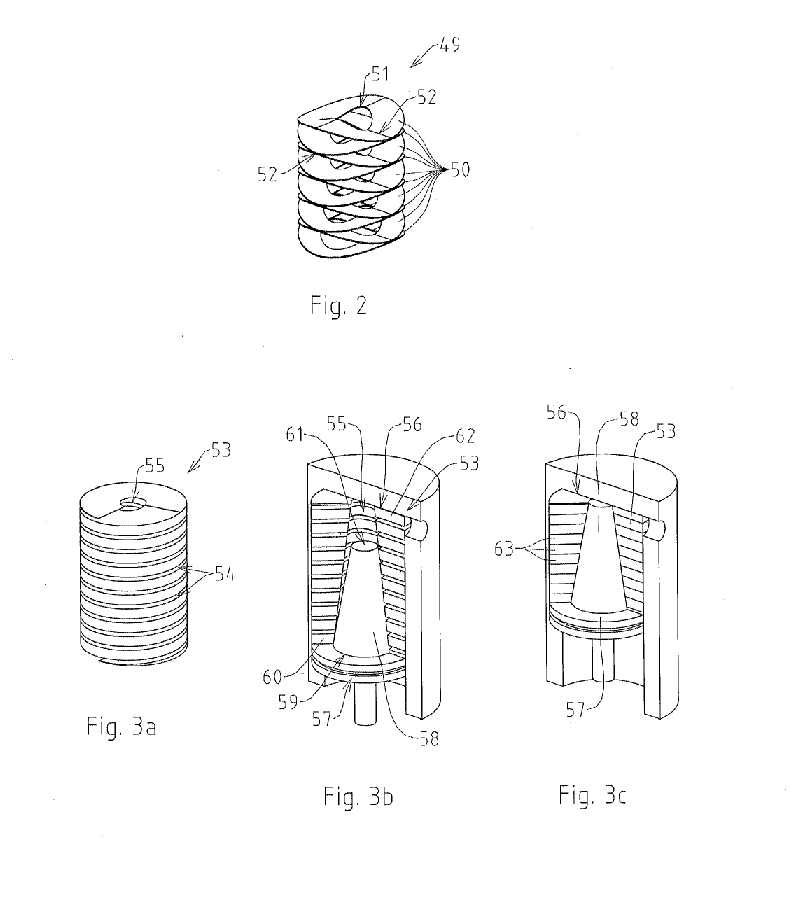

FIG. 2 shows a diagram of an alternative thermal transfer element to be used in one chamber of a piston machine according to the invention;

FIG. 3a shows a diagram of a spiral-shaped thermal transfer element;

FIGS. 3b and 3c, respectively show diagrams in partial cross-section of the thermal transfer element according to FIG. 3a in one chamber and a partially open and a completely compressed position, respectively;

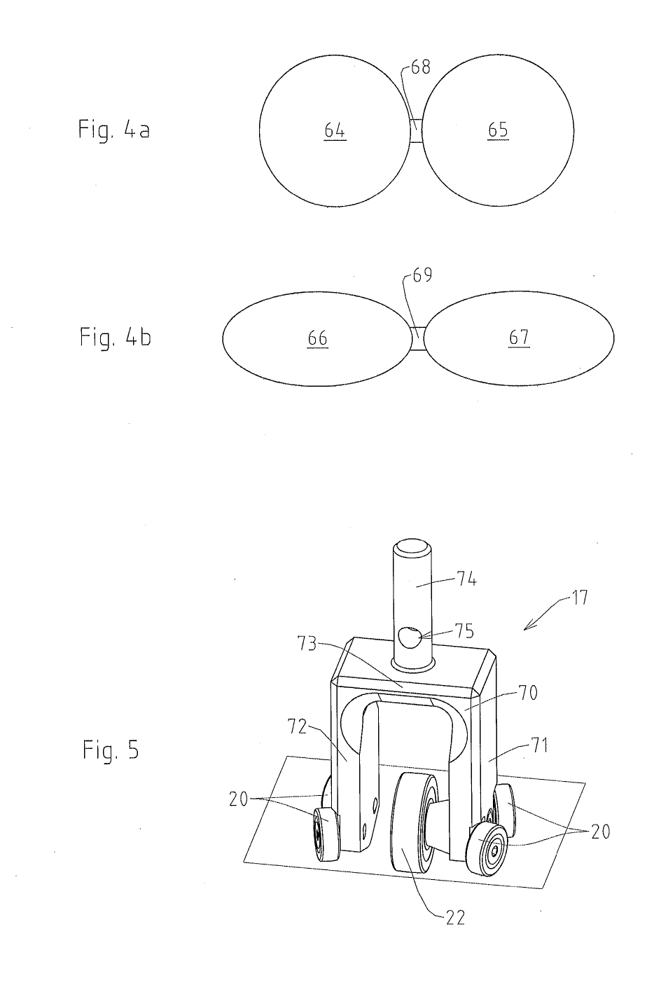

FIGS. 4a and 4b, respectively show a top view of two different chamber geometries, having a circular and elliptic base, respectively;

FIG. 5 shows a diagram of a roll element having lateral guide rolls;

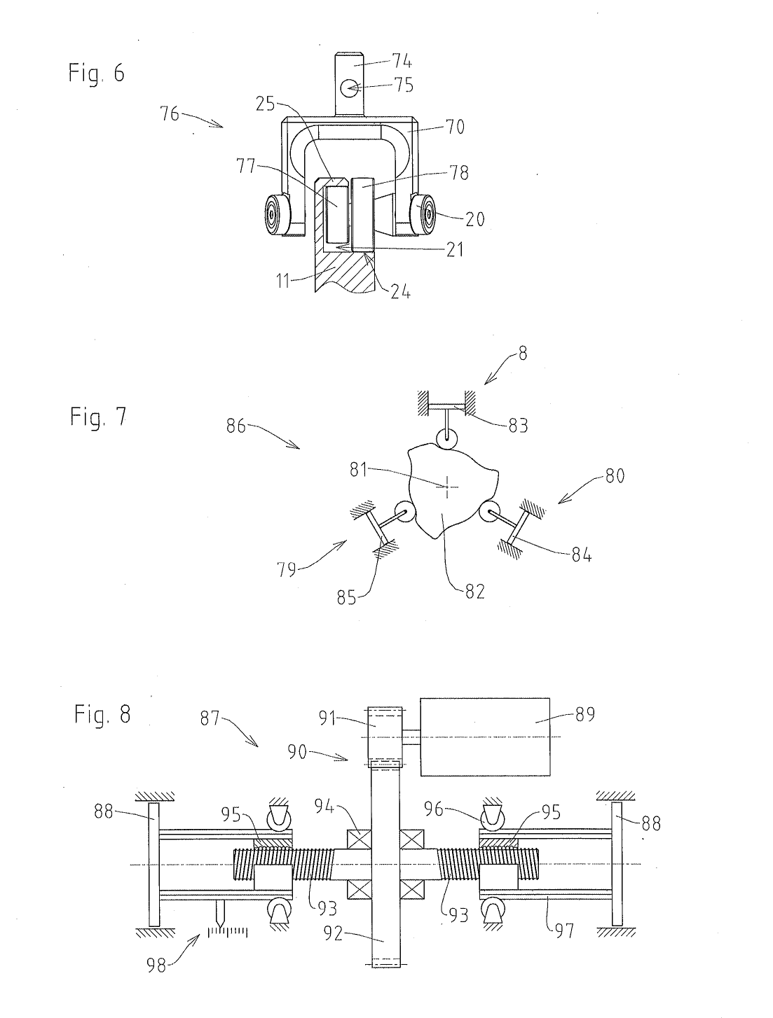

FIG. 6 shows a partial sectional view of an alternative roll element having two profile rolls;

FIG. 7 shows a schematic view of a rotary-symmetric disk cam, connected to which are three pistons, along a rotational axis;

FIG. 8 shows a schematic partial sectional view of a device having two related pistons of different chamber arrangements, of a common motor-generator-unit and interconnected train of gears and dual clutch transmission turning clockwise or counterclockwise;

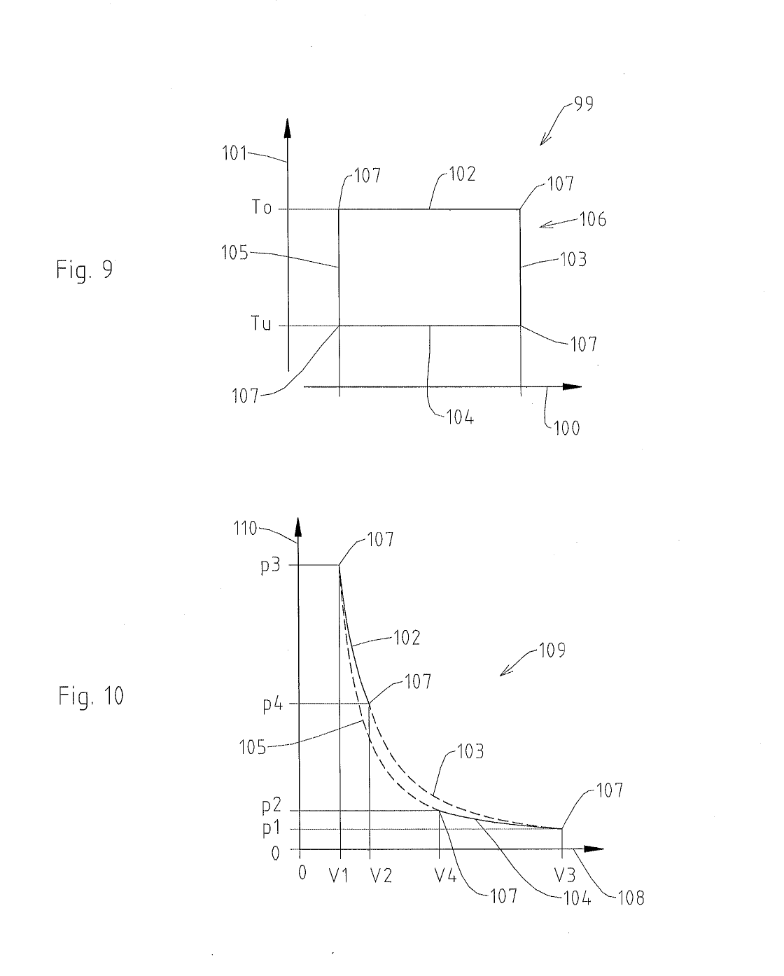

FIG. 9 shows a temperature-entropy diagram of the ideal Carnot cycle;

FIG. 10 shows a pressure-volume diagram of the ideal Carnot cycle;

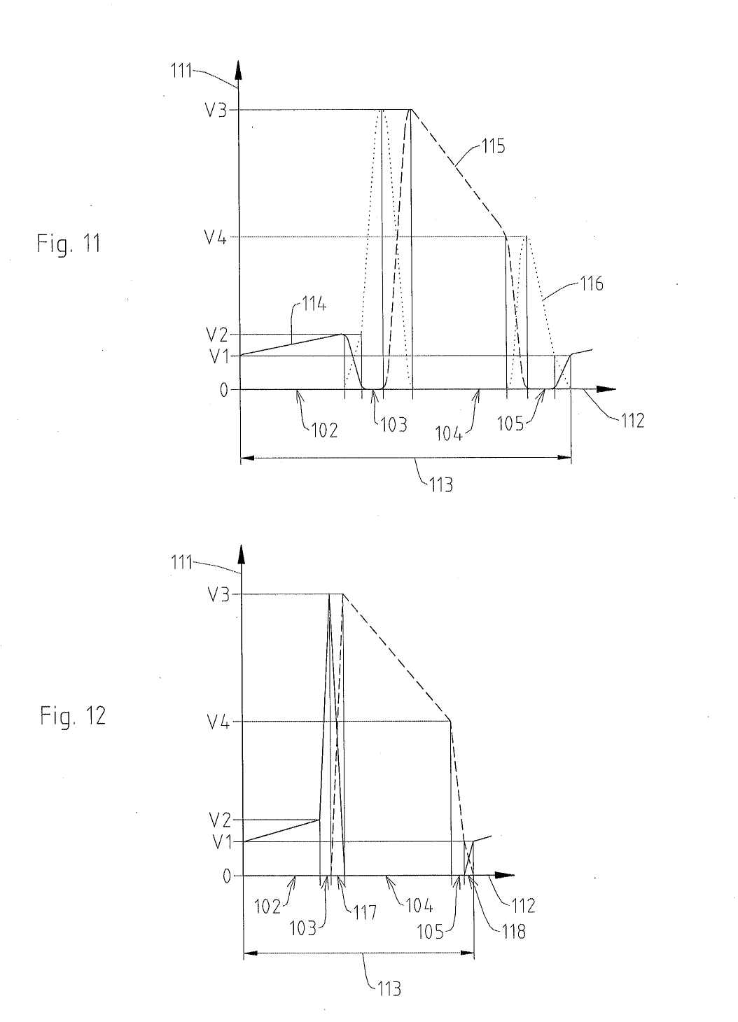

FIG. 11 shows a diagram of the various partial working volumes of a chamber arrangement having three chambers as a function of time during a cycle run;

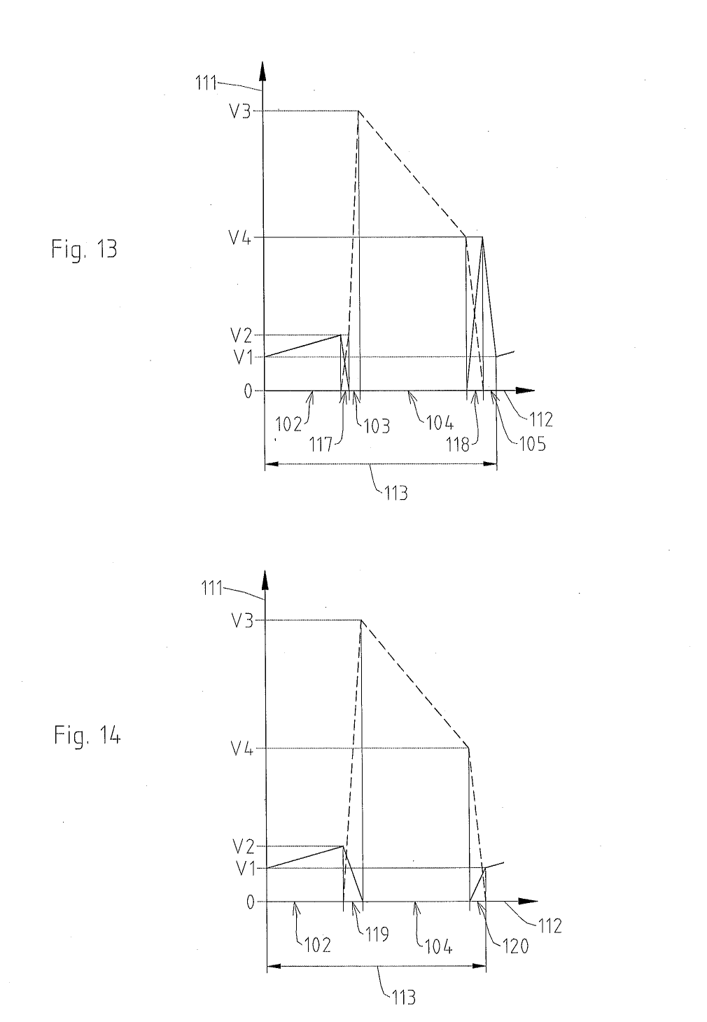

FIG. 12 shows a diagram of the various partial working volumes of a chamber arrangement having two chambers as a function of the time during a cycle run;

FIG. 13 shows a diagram of the various partial working volumes of a chamber arrangement having two chambers as a function of the time during a cycle run, wherein the changes of state occur in other chambers as compared to FIG. 12;

FIG. 14 shows another variant of the time course of the individual working volumes;

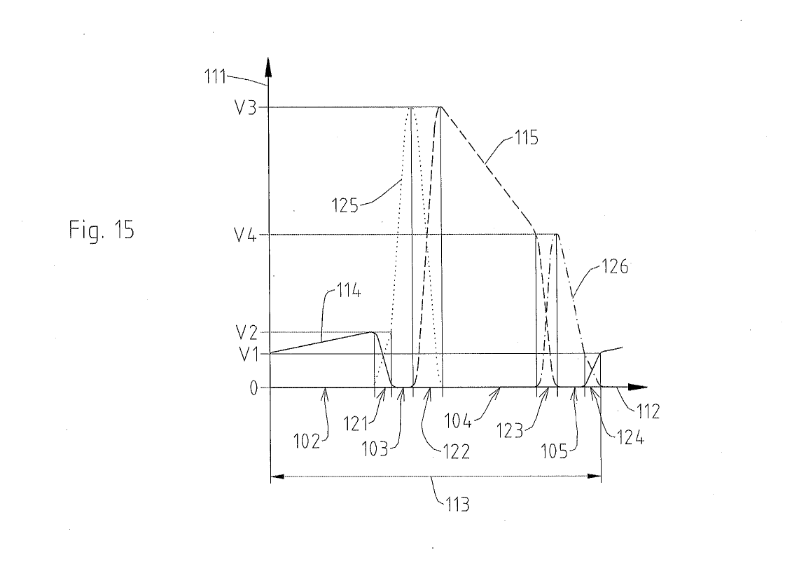

FIG. 15 shows a diagram of the various partial working volumes of a chamber arrangement having four chambers as a function of the time during a cycle run; and

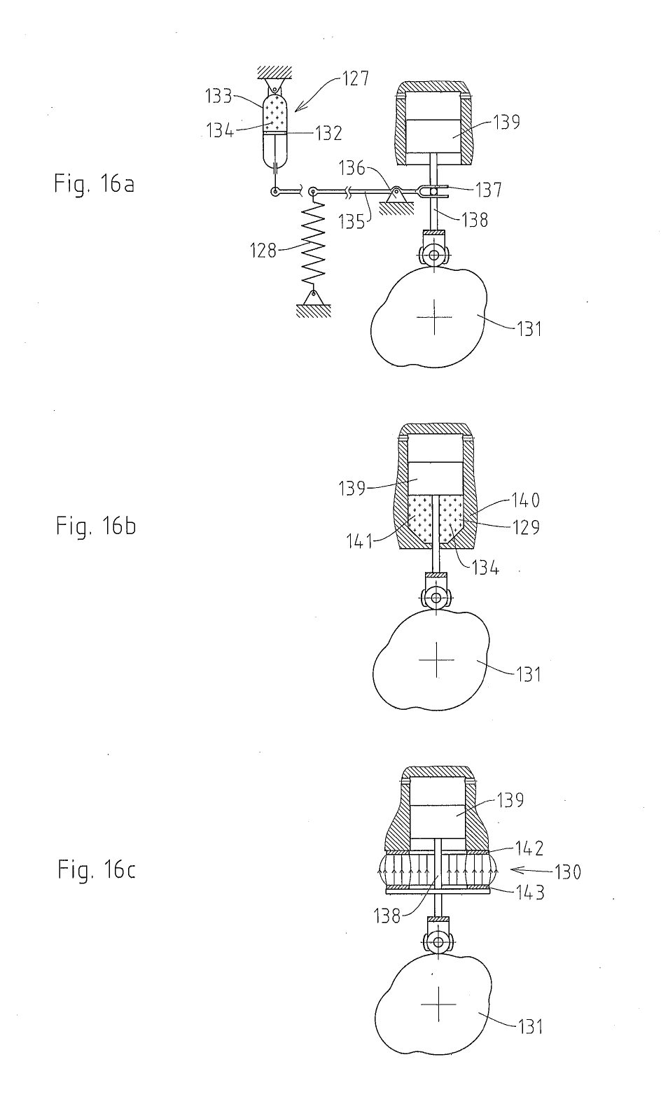

FIGS. 16a-c show schematically different types of spring elements to support an actuating element.

FIG. 1 shows a piston machine 1 for converting heat into work or for heating or cooling by the application of work. The piston machine 1 comprises three chambers 2, 3, 4 each comprising one piston 5, 6, 7 allocated to the respective chamber 2, 3, 4. The three chambers 2, 3, 4 together form the only chamber arrangement 8 of the piston machine 1. The chambers 2, 3, 4 are connected via connecting ducts 9, 10 between the chambers 2 and 3 and 3 and 4, respectively, wherein no direct connecting duct is present between the two external chambers 2, 4, however, these two chambers 2, 4 communicate with each other only via the middle chamber 3. For the purpose of avoiding any disadvantageous space (dead space), the connecting ducts 9, 10 connecting the chambers 2, 3, 4 are provided with volumes which are as small as possible but comply with the requirements of a resistance-free flow through, whenever possible.

A single piston 5, 6, 7 is arranged in each chamber 2, 3, 4. The cross-sections of the pistons 5, 6, 7 between the chambers 2, 3, 4 are different, however. Each piston 5, 6, 7 is connected to an actuating element in the form of a disk cam 11, 12, 13, wherein the three disk cams 11, 12, 13 are connected to a common axis 14 in a torque-proof manner. The disk cams 11, 12, 13 control the movement of the respective piston 5, 6, 7 or are adapted for the power transmission from and to the pistons 5, 6, 7. The axis 14 of the disk cams 11, 12, 13 is supported in a rack 15, which simultaneously supports the chamber arrangement 8. The pistons 5, 6, 7 are arranged vertically above the axis 14 of the disk cams 11, 12, 13 and connected to the disk cams 11, 12, 13 via connecting elements 16.

The connection of the pistons 5, 6, 7 to the disk cams 11, 12, 13 is effected mainly via arc-shaped roll elements 17, which are supported on the disk cams 11, 12, 13 and are associated with the pistons 5, 6, 7 via piston rods 18. In addition, the roll elements 17 (cf. FIG. 5 for a detailed illustration) are supported also on lateral guide rails 19, so as to prevent any losses during the power transmission, e. g. in the form of lateral power components. Two guide rolls 20 (cf. FIG. 5) mounted laterally on the roll elements 17 are each in contact with one guide rail 19 on each side.

The disk cams 11, 12, 13 comprise on their circumferences, section by section, a profile groove 21 which is open to the rotational axis at the radially variable distance, engaging in which is the respective one profile roll 22 of the roll elements 17. The profile groove 21 is formed by a sidewall 23 which is thinner as compared to the disk cam 11, 12, 13, which sidewall increases the disk cam 11, 12, 13 radially outwards, and by an external wall 25 essentially following the course of the external edge 24 of the disk cam 11, 12, 13. It is the function of the external wall 25 to be able to also exert tensile forces on the piston 5, 6, 7, besides the compression forces exerted by the disk cam 11, 12, 13. In sections 26 each corresponding to a dead phase of the piston 5, 6, 7 allocated to the respective disk cam 11, 12, 13, that is in a position of the piston 5, 6, 7 completely pushed into the respective chamber 2, 3, 4, therefore the profile groove 21 can be interrupted for this reason and the profile roll 22 can be supported only on the external edge 24 of the disk cam 11, 12, 13, since starting from this position no tensile forces from the piston 5, 6, 7 are possible.

The upper side of each roll element 17 is rigidly connected to a piston rod 18 via an adjusting element 27, by means of which the distance between the roll element 17 and the piston 5, 6, 7 can be adjusted accurately. The actual piston 5, 6, 7 is arranged on the other end of the piston rod 18, wherein the three pistons 5, 6, 7 have different designs depending on their different tasks. Two of the piston rods 18 of the piston 5, 6 are surrounded by a shell 18′ each, thermally insulating the piston rod from the surroundings.

The piston 5 on the left-hand side is arranged in a warm chamber 2, i. e. the working temperature of this chamber 2 is higher than that of the cold chamber 4 on the right-hand side. Accordingly, the piston 5, just as well as the sidewall 28 of the warm chamber 2, is insulated to the outside, which is indicated by insulating layers 29, wherein several mirrored heat shields are integrated in the insulating layer 29, to minimize any heat transfer by radiation. The insulating layer 29 itself consists of aerogel. However, it is also possible to remove the aerogel and evacuate the space made available, since said space is designed in a stable and airtight manner. Other available insulating materials such as mineral wool may also be used instead of the aerogel. In addition, the left-hand and the middle chambers 2, 3 of the chamber arrangement 8 are connected at a distance to the base element 8′ of the chamber arrangement 8 via three pins 29′ only, which in turn are hollow and are made up of a material having a poor thermal conductivity. The internal surface of the base element 8′ of the chamber arrangement 8 and the external surface of the left-hand and middle chambers 2, 3, so to speak, define the space between them, which is filled by the insulating layer 29. A thermal transfer element 30 is fixed in the upper part of the chamber 2, which element is surrounded by a heating chamber 31. Thus, the thermal transfer element 30 separates the heating chamber 31 from the remaining chamber 2 or from the partial working volume 33 of the warm chamber 2. The thermal transfer element 30 comprises thermal transfer surfaces 34 towards the bottom side facing the piston 5, to increase the surface area of the warm chamber 2, in that the bottom surface follows a serrated course, whereby the transverse thermal transfer surfaces 34 of the teeth existing in the warm chamber 2 are arranged such that the upper and lower edges 35, 36 each lie in one plane, and seen from a top view, enclose a right angle with the axis of a connecting duct 9 to the middle chamber 3. On the opposite upper side of the piston 5, a complementary thermal transfer element 37 is arranged, which consequently is likewise serrated and is moved with the piston 5, with its teeth being snugly insertable in the intermediate spaces of the teeth of the upper thermal transfer element 30 when the piston 5 is completely pushed into the chamber 2, so that essentially no dead space remains between the thermal transfer elements 30, 37. Accordingly, the partial working volume of the warm chamber 2 is limited by the two thermal transfer elements 30, 37 and the internal surface of the sidewall 28 of the chamber 2 or the cylinder. The heating chamber 31 comprises at both sides line connections 38, 39 facilitating delivery and removal of a heating medium, for instance, warm air or a fluid into or from the heating chamber 31, so that the temperature of the upper thermal transfer element 30 as well as the lower thermal transfer element 37, which is in contact with the former over a large surface during a dead phase, may virtually be brought to the temperature of the heating medium. Both the line connections 38, 39 and the upper side of the heating chamber 31 have the same insulation 29 as the sidewall 28 of the warm chamber 2 and the piston 5.

The connecting duct 9 to the middle chamber 3 is arranged in the sidewall 28 of the warm chamber 2 at about the level of the lower edges 36 of the teeth of the upper, unmovable thermal transfer element 30. To facilitate the flow of the working medium through the connecting duct and into the middle chamber 3 during the compression of the warm chamber 2, the lower tips of the upper thermal transfer element 30 as well as the feet (i. e. in lower area of the teeth) of the lower thermal transfer element 37 are penetrated by narrow flow-through channels 40, allowing the flow of the working medium to take a shortcut. In a completely compressed position of the piston 5, i. e. when the piston 5 is completely inserted into the chamber 2 (cf. piston 7 in the cold chamber 4), the flow-through channels 40 of the two thermal transfer elements 30, 37 open into the flow-through channels 40 of the respective other thermal transfer elements 37, 30. In this position, preferably all flow-through channels 40 are in one plane and on the level of the connecting duct 9.

The middle chamber 3, which is connected to the warm chamber 2 by means of the short connecting duct 9, which is just long enough to cross the sidewalls 28, 41 of the warm chamber 2 and the middle chamber 3 by the shortest routes, has likewise a circular base surface, but which is more than twice as large as that of the warm chamber 2. The connecting duct 9 is plugged in the sidewalls 28, 41 of the warm chamber 2 and the middle chamber 3 with a spherical end in an articulated and somewhat shiftable manner, thus taking into consideration a minor change of position of the warm and middle chambers 2, 3 during the operation. The internal space of the middle chamber 3 is purely cylindrical, i. e. no thermal transfer surfaces are provided to increase the surface area. On the contrary, both the sidewall 41 of the chamber 3 and the upper internal surface as well as the inner side of the piston 6, i. e. the side of the piston 6 arranged in the chamber, which side is facing the partial working volume of the middle chamber 3, are insulated, so that any heat exchange with the working medium is avoided in the best possible manner. In the shown compressed position, the piston 6 essentially reduces the available partial working volume of the chamber 3 to zero, whereby the flat upper surface of the piston 6 is adjacent on the upper flat inner side of the chamber 3. To allow the working medium to exit the chamber 3 during the compression of the working medium without any difficulty, the upper flat inner side of the chamber 3 is arranged on the level of the connecting duct 9 to the warm chamber 2.

Opposite the connecting duct 9 to the warm chamber 2, the sidewall 41 of the middle chamber 3 comprises a further connecting duct 10 connecting the partial working volume of the middle chamber 3 with that of the cold chamber 4. The two connecting ducts 9, 10 are preferably on the same level and, in the present example, even in one line. For a better removal of the working medium, the upper inner side of the chamber 3 comprises a peripheral recess of the type of an external drain 42, so that any working medium pressed to the outside by the piston 6 during the compression can reach one of the lateral connecting ducts 9, 10 through the ring-shaped drain 42. Such a discharge possibility is especially advantageous since, depending on the position in the cycle, draining is provided or possible only through one of the two connecting ducts 9, 10, so that the working medium may better pass from one side to the other side through the drain 42.

The cold chamber 4 connected to the middle chamber 3 and located opposite the warm chamber 2 comprises thermal transfer elements 43, 44 comparable to the warm chamber 2, whose serrated surface forms inclined thermal transfer surfaces 45 to increase the surface area of the inner side of the chamber. Unlike the warm chamber 2, neither the sidewall 46 of the chamber 4 nor its upper side 47 or the piston 7 is insulated to the outside. On the contrary, convectors 48 are connected to the chamber 4 and the piston 7 on all sides, so that the working temperature of the cold chamber 4 can possibly be kept at the ambient temperature of the piston machine 1. The convectors 48 have a serrated shape which basically can be compared to the thermal transfer elements 43, 44, with their edges being aligned at a right angle on the edges of the thermal transfer elements 43, 44 arranged in the chamber 4, however. Of course, other known heat exchangers might also be used instead of the convectors 48.

If the axis 14 rotates in one direction, so that the approximated Carnot cycle takes place in a clockwise direction, the piston machine 1 according to the invention can be operated as a prime mover (motor), wherein mechanical work is delivered on the axis 14, heat is fed to the warm chamber 2 (the working medium) at the upper cycle temperature, and the cold chamber 4 gives off heat to the surrounding area as so-called waste heat at the lower cycle temperature, so as to balance the entropy. If the axis 14 rotates in the other direction, so that the approximated Carnot cycle takes place in a counterclockwise direction, the piston machine 1 according to the invention can be operated as a machine (refrigerating machine, heat pump), wherein mechanical work is delivered to the axis 14, heat is fed to the cold chamber at the lower cycle temperature, or the cold chamber 4 withdraws heat from the surrounding area at the lower cycle temperature and the warm chamber 2 gives off heat as usable heat or waste heat at the upper cycle temperature, depending on the application and approach, so as to again balance the entropy. The shapes or contours of the disk cams 11, 12, 13 or the motion profiles determined by them are not only different between the outer chambers 2, 4 and the middle chamber 3, but also between the outer chambers 2, 4, the difference of the motion profiles of the pistons 5, 7 allocated to the outer chambers 2, 4 becoming apparent above all by their sense of direction.

FIG. 2 shows a garland-like thermal transfer element 49 in a partially expanded position. As can be seen in this Figure, the surface area of this thermal transfer element 49 exceeds its base surface many times over. The garland-like thermal transfer element 49 is composed of a stack of several ring-shaped disks 50 connected to one another to both sides, that is to say to the two adjacent disks 15. The outer circumferences of all disks 50 are identical, however the radius of the inner edge 51 increases from top to bottom in the stack, that is the bottommost ring-shaped disk 50 is narrower than the disks 50 above it. The garland-like structure is obtained by forming the connections 52 to the neighboring disks 50 only along a connecting line extending through the center of the disks 50 and the connecting lines on the upper side and lower side of each disk 50 crossing each other, in particular at the right angle.

One variant of a garland-like thermal transfer element 49 is shown in FIG. 3a, wherein said thermal transfer element 53 essentially has the shape of a spiral. In a partially expanded position, such as is shown in FIG. 3a, each winding of the spiral contributes to increasing the surface area, that is the surfaces of every single winding form the thermal transfer surfaces 54 for a working medium available there between or enveloping the spiral. Just like in the above described thermal transfer element 49, the internal radius of the spiral increases from top to bottom, so that spiral forms a conical inner space 55.

In FIGS. 3b and 3c the spiral-shaped thermal transfer element 53 according to FIG. 3a is shown as being arranged in a chamber 56 together with the piston 57. Instead of the spiral-like thermal transfer element 53, the thermal transfer element 49 according to FIG. 2 could be used here just as well, so that the following description of the other thermal transfer elements 49 may be applied analogously. The shown heat transfer element 53 can both be connected at the top to the inner side of the chamber 56 as well as at the bottom to the top side of the piston 57. Such a connection is necessary, when the position of the free state of the thermal transfer element 53 is smaller than the maximally expanded position in the chamber 56, since in this case the thermal transfer element 53 has to be pulled apart against the spring force exerted by it. FIG. 3b shows a partially expanded position. A conical pin 58 can be seen in the inside of the thermal transfer element 53, which projects into the conical inner space 55 formed by the thermal transfer element 53, wherein the radius of the pin 58 on its bottom side 59 corresponds to the inner radius of the bottommost layer 60 of the thermal transfer element 53. In addition, the radius of the pin 58 on the top end 61 corresponds to inner radius of the uppermost layer 62 of the thermal transfer element 53. Thus, in a compressed position, the pin 58 completely fills the thermal transfer element 53, such as can be seen in FIG. 3c. The layers 63 of the thermal transfer elements 53 are directly adjacent, so that there essentially remains no dead space in the respective chamber 56.

Of course, instead of the above shown cylindrical base surfaces, other shapes are also conceivable for the chambers. For example, FIGS. 4a and 4b show a comparison of two chambers 64, 65 or 66, 67 with circular or elliptic base surfaces, the surfaces being identical in terms of the amount. As can be seen from the comparison, in the case of identically long connecting ducts 68 or 69 between the sidewalls of the elliptic chambers 66, 67 facing each other, there is more space than in the circular chambers 64, 65, so that the elliptic chambers 66, 67 thermally may be better insulated from each other than the circular chambers 64, 65.

FIG. 5 is an enlarged view of one of the roll elements 17 according to FIG. 1. The roll element 17 essentially consists of an arc-shaped or bridge-shaped base element 70 having two sidewalls 71, 72 and one bridge element 73 connecting the two sidewalls 71, 72. A profile roll 22 is supported between the two sidewalls 71, 72 on one side, so that a distance remains between the profile roll 22 and the opposite sidewall 72. Two smaller guide rolls 20 are supported each on the outside of the two sidewalls 71, 72, whose axes are angled relative to an axis of the profile roll 22, however advantageously lying therewith in one plane. All rolls 22, 20 are provided with ball bearings which are mainly frictionless. A connecting pin 74 is formed on the top of the bridge element 73, which comprises an aperture 75, for example for a coupling journal, and is equipped for being connected to a piston rod 18 (cf. FIG. 1).

One improved variant of the roll element 17 according to FIG. 5 is shown in FIG. 6 together with a cross-sectional view of the profile groove 21 of a disk cam 11, wherein this roll element 76, instead of a single profile roll 22, comprises two independent profile rolls 77, 78 having different diameters. The larger profile roll 78 is designed to rest on an external edge 24 of the disk cam 11, while the smaller profile roll 77 is designed to rest on the external wall 25 of the profile groove 21. Accordingly, the two profile rolls 77, 78 rotate in opposite directions of rotation upon movement of the cam disk 11. The advantage of such a roll arrangement lies in that the two profile rolls 77, 78—in contrast to a single profile roll 22 which rests on the outer edge 24 of the cam disk 11 and on the external wall 25 of the profile groove 21 in alternating fashion—do not have to change their sense of direction at any time during a complete revolution of the cam disk 11.

FIG. 7 schematically shows an option of broadening the piston machine 1 according to FIG. 1. In addition to the piston arrangement 8 shown in FIG. 1, two other piston arrangements 79, 80 can be arranged symmetrically about the axis of rotation 81 of the cam disk 82, wherein three identical pistons 83, 84, 85 of the different piston arrangements 8, 79, 80 are connected to one joint cam disk 82. The cam disk 82 has a symmetry corresponding to the piston arrangements 8, 79, 80, in this case a trigonal rotational symmetry. In such a piston machine 86, the same changes of state of identical cycles are performed at the same time in the chamber arrangements 8, 79, 80, whereby always identically large forces symmetrically directed onto the cam disk 82 act upon the cam disk 82, so that no resulting radial force acts on the axis of rotation 81, and thus any losses, for example, in the bearings of the axis of rotation 81 can be reduced, and an almost vibration-free operation of such a piston machine is given. Furthermore, the mass inertia effects of the pistons 83, 84, 85 of the chamber arrangements 8, 79, 80 cancel each other out. To obtain an effect of the same kind by means of a different design, a curve ring comprising a curve element located on the inner diameter could be used instead of the cam disk 82, wherein the symmetrically arranged chamber arrangements would be positioned centrally on the axis of rotation of the ring, wherein the roll elements would be directed outwards to the curve elements of the curve ring.

FIG. 8 shows a partial cross-section of the piston machine 87 comprising opposing chamber arrangements, of which only the related pistons 88 with their joint actuating element 89, a motor-generator unit, which is designed to both apply and receive torques, is shown here only schematically. Between the actuating element 89 and the pistons 88 allocated to the actuating element 89, a joint train of gear 90 comprising the gear wheels 91, 92 and a ball screw spindle 93 is interconnected, wherein one runs in a counterclockwise direction and the other in a clockwise direction. Both ball screw spindles 90 have the same pitch and number of turns, are connected to one another in a torque-proof manner and are to be understood as a single double ball screw spindle having counter-threads supported by two bearing points 94. The nuts 95, one nut 95 and one ball screw spindle 93 forming together the ball screw drive, are each connected to the piston 88 by means of a guide track 97 supported between two rolls 96. The linear movement of at least one of the pistons 88 is recorded by means of displacement measurement 98. In this arrangement, the mass inertia forces of the pistons 88—assuming that they are of the same design—as well as the elements rigidly connected thereto—assuming that they likewise have the same design—cancel each other out.

As pointed out in the above, the basically known model cycle of the piston machine 1 according to the invention is the Carnot cycle. The diagram 99 shown in FIG. 9 qualitatively describes the relationship between temperature and entropy of the working medium during a run of the cycle. The entropy inherent in the working medium is recorded on the axis of abscissas 100, while the temperature of the working medium is recorded on the axis of ordinates 101. The four edges 102, 103, 104, 105 of the rectangular course 106 of the cycle represent each a change of state of the working medium and connect four points of state 107 in the corners of the rectangle. The edges 102, 104 parallel to the axis of abscissas 100 correspond to isothermal changes of state 102, 104 at an upper temperature To and a lower temperature Tu and the edges 103, 105 parallel to the axis of ordinates 101 correspond to isotropic changes of state 103, 105 at different entropy levels. Depending on whether the piston machine 1 is used for converting heat into work or for heating or cooling by the application of work, the thermodynamic state of the working medium varying during the cycle follows the rectangle 106 in a clockwise or counterclockwise direction, respectively.

FIG. 10 shows the same—basically known—cycle as is shown in FIG. 9 in another coordinate system or diagram. The working volume of the working medium is recorded on the axis of abscissas 108 of this p-V diagram 109 and its pressure is recorded on the axis of ordinates 110. Points of state 107 succeeding during the cycle run are on different pressure and volume levels, that is to say there do not exist any isobaric or isochoric changes of state. The two isothermal changes of state 102, 104 are shown as solid lines and the two isentropic changes of state 103, 105 as dashed lines. As can be seen particularly well in this diagram 109, the changes of volume, relating to the absolute difference value, in the shown Carnot cycle are of a different magnitude during the isothermal changes of state 102, 104; in particular the change of volume necessary at the higher temperature To—i.e. in the warm chamber 2—is considerably smaller than that at the lower temperature Tu—i.e. in the cold chamber 4. In addition, the change of volume during the isentropic changes of state 103, 104 also depends on whether there is an isentropic compression or isentropic expansion: for example, in a thermal engine (shown cycle, clockwise) the change of volume during the isentropic compression 105 is smaller than during the isentropic expansion 103. As compared to the following figures, the working volumes V1, V2, V3, V4 in the four points of state 107 are recorded on the axis of abscissas 108 and, for the sake of completeness, the associated pressures p1, p2, p3, p4 are recorded on the axis of ordinates 110.

FIGS. 11 to 15 each show a qualitative diagram of the partial working volumes of the chambers of a chamber arrangement of the piston machine according to the invention, in dependence on the time and for a complete run 113 or complete working cycle. In addition, on the axis of ordinates 111, on which the partial working volumes are recorded, for the purpose of orientation, the volume levels V1, V2, V3, V4 recorded in the diagram in FIG. 10 are recorded at the points of state 107. In addition, on the axis of abscissas 112, on which the time or the position within the run 113 is recorded, the changes of state, as designated in the diagrams in FIG. 9 and FIG. 10, are recorded, wherein no change of state takes place during some time periods, for example, when the working medium stays at one point of state 107.

FIG. 11 shows the course of the partial working volumes of the three chambers 2, 3, 4 in a piston machine 1 according to FIG. 1. The solid line 114 represents the partial working volume or its course in the warm chamber 2, the dashed line 115 represents the partial working volume in the cold chamber 4, and the dotted line 116 represents the partial working volume in the middle chamber 3. At the origin of the time axis 112, the working medium is completely in the warm chamber 2 and isothermally expands during the first time period 102 (of course, approximately), i.e. thermal energy is added. Once the isothermal expansion 102 has been concluded, the working medium is supplied from the warm chamber 2 into the middle chamber 3, in that the partial working volume of the warm chamber 2 is compressed and that of the middle chamber 3 simultaneously expands at the same rate. The thermodynamic state of the working medium does not change in the meantime, i. e. despite a constant working volume V2 this transition does not constitute any isochoric change of state, since this change is to be considered to be abiatic by virtue of the short period of time and the above described construction of the middle chamber 3. Once the working medium has been fully supplied into the middle chamber 3 and the partial working volume 114 of the warm chamber 2 thus has dropped to zero, the isentropic expansion 103 or its period of time begins, which expansion takes place much faster than the isothermal expansion 102, so that any heat exchange is avoided as far as possible. Once the working medium has reached the maximum working volume V3, it is supplied from the middle chamber 3 into the cold chamber 4, in an analogous manner as in the above, where subsequently the isothermal compression 104 takes place and the working medium gives off thermal energy to the chamber 4 and consequently to the surroundings. Then, the working medium again changes over into the middle chamber 3, in which the isentropic compression 105 occurs after the change of chambers. After another changeover back into the warm chamber 2, the next run 113 starts. As can be seen from the run of the partial working volumes, at least the partial working volume 114 of the warm chamber 2 or the partial working volume 115 of the cold chamber is essentially zero at any time. During the isentropic changes of state 103, 105 even both partial working volumes 114, 115 are essentially zero. In addition, it can be seen from the diagram in FIG. 11 that the two isentropic changes of state 103, 105 need less time than the two isothermal changes of state 102, 104, the isentropic expansion 103 at the same time occupying the largest volume range and one of the smallest periods of time, so that the rate of the change in volume during the isentropic expansion 103 is one of the largest one. Moreover, the diagram of FIG. 11 shows that the working volume is essentially always split up into the partial working volumes 114, 115, 116 of one or two chambers 2, 3, 4.

The diagrams in FIGS. 12 to 14 show courses of the partial working volumes of a piston machine comprising one or several piston arrangements, each having only two pistons. In the case of two chambers—in contrast to the operation of a 3-chamber machine shown in connection with FIG. 11—there can be no separate piston for the isentropic changes of state 103, 105. Since thus the isentropic changes of state 103, 105 have to take place in a chamber 2, 4 subjected to one of the cycle temperatures To, Tu and preferably comprising thermal transfer surfaces 34, 35, a heat exchange can be prevented only by the highest possible speed of the change of state 103, 105. In addition, the working medium inherently must be supplied directly from the warm chamber into the cold chamber and vice versa.

In the method according to FIG. 12, after the isothermal expansion 102, also the isentropic expansion 103 still takes place in the warm chamber and the working medium is delivered into the cold chamber 4 during a change of chambers 117 at a maximum volume V3. In addition, the isentropic compression 105 follows the isothermal compression 104 prior to effecting a change of chambers 118 back into the warm chamber. Accordingly, the changes of chambers 117, 118 always follow the isentropic change of state 103, 105.

As compared to FIG. 12, in a method according to FIG. 13, the changes of chambers 117, 118 are effected prior to the isentropic changes of state 103, 105. Accordingly, the isentropic expansion 103 takes place already in the cold chamber 4 directly prior to the isothermal compression 104, and the isentropic compression 105 follows after a change of chambers 118 as well as directly thereupon the next isothermal expansion 102 in the warm chamber. Said method has the advantage of that only the cold chamber has to contain the maximum volume V3 and the chamber cross-section may be adapted accordingly.

While in the present methods and operating modes the working medium changes over from one chamber into the next chamber in a processing step of its own—however, without changing the thermodynamic state of the working medium—in the method according to FIG. 14 a change of chambers simultaneously takes place with an isentropic change of state. Immediately following the isothermal expansion 102, which inherently takes place in the warm chamber, starts a compression of the warm chamber, which is accompanied by a considerably faster expansion of the cold chamber. Thus, the working volume is increased in total, which approximates an isentropic expansion at a correspondingly high speed. At the end of this combined change of chambers 119, the isothermal compression 104 may immediately start. Once the latter has been terminated, the second change of chambers 120 occurs in parallel to the isentropic compression, i. e. the cold chamber compresses clearly faster than the warm chamber is expanding. At the end of this change, the isentropically compressed working medium is already completely in the warm chamber again. Thus, this method really requires only four processing steps during one run 113.

Mixed forms of the methods shown in the diagrams of FIGS. 12 to 14 are also possible, which will not be referred to in more detail, since they are partially analogous to the methods already mentioned above.

Finally, FIG. 15 schematically shows the operation of a piston machine comprising four chambers according to the invention by means of the operations of the partial working volumes. In this connection, a chamber of its own is provided for the isentropic expansion 103 and the isentropic compression 105. The working medium circulates in one direction through the four chambers (the warm chamber can be connected directly to the cold chamber via a further connecting duct), with separate processing steps being provided for the thermodynamically static changes of chamber 121, 122, 123, 124. The diagram shows the course of the partial working volume in the warm chamber 114, in the cold chamber 115 as well as in the isentropically expanding chamber 125 and the isentropically compressing chamber 126. If the isothermal compression 104 starts exactly at half the working cycle 113 or if the expansion portion and the compression portion of a run 113 last the same time, in such an arrangement two working volumes can also work simultaneously in one chamber arrangement, wherein the working volumes are always within or between opposite chambers and the connecting ducts have to be equipped with valves. As of a chamber arrangement comprising six chambers, two or more working volumes with even more chambers are also possible without any valves.

Of course, the embodiments shown and described may also be modified or extended in a professional manner within the scope of the invention. For example, instead of the external heat supply by means of a heating medium, an inner combustion in one of the chambers may also be provided, which may be adapted to the motion profiles of the piston arranged in the warm chamber by a time-wise variable amount of fuel supplied. Other possibilities of transferring heat onto one of the pistons, such as concentrated sunlight or a flame directed onto a thermal transfer element from outside, are also within the scope of what is considered to be used by the person skilled in the art.

It will be mentioned for the sake of detail that the time courses of the partial working volumes shown in FIGS. 11 to 15 can be understood as time courses of the piston positions within their chambers in consideration of the respective piston surface projected in the direction of stroke, which in turn corresponds to the motion profiles of the respective pistons. If a motion profile starts and ends during a dead phase period, these dead phase periods in combination result in one dead phase.

FIGS. 16a-c show spring elements 127, 128, 129, 130 to support an actuating element 131. FIG. 16a shows a piston 132 working in an opposite direction and a coil spring 128. The piston 132 is accommodated in a closed cylinder 133, so that each movement of the piston 132 is accompanied by a compression or decompression of a compression medium 134 contained in the cylinder 133. Both spring elements 127, 128 are connected to a guide fork 137 via a bar 135 and a rocker 136, which guide fork is coupled to a piston rod 138 of the piston 139 of the piston machine in such a way that a linear piston motion of the piston 139 is transferred onto a pivoting motion of the bar 135 and vice versa. By virtue of the lever arm with respect to the rocker 136, the extent of support by means of the spring elements 127, 128 can be determined design-related. In FIG. 16b the spring element 129 is integrated directly into the cylinder 140 of the piston 139. Here, a closed chamber 141 comprising a compression medium 134 is provided below the piston 139. FIG. 16c shows a magnetic spring element 130 which is formed with ring magnets 142, 143 aligned in a manner attracting one another. The ring magnets 142, 143 are circularly arranged about the piston rod 138 and support a compression motion of the piston 139, while withdrawing energy from a decompression motion and temporarily storing it as potential energy.

There are manifold fields of application of the invention, i. e. of the piston machine according to the invention and a method according to the invention. In particular, depending on the design and mode of operation of the piston machine, applications as drives for a generator for the production of electrical energy or for the direct production of electrical energy by means of the motor-generator unit possibly used as an actuating element or as a heat pump, e. g. for a single-family house or as a refrigerating machine for industrial applications are taken into consideration.

1-37. (canceled)

38. A piston machine for converting heat into work or for heating or cooling by the application of work,
having at least one chamber arrangement, which comprises at least two chambers connected by at least one connecting duct, wherein at least two of the chambers are substantially thermally insulated against one another and have different capacities and working temperatures, and
having pistons which are impermeable to a working medium and are movably arranged in their respective chambers to vary a partial working volume bounded by the chamber and the piston,
wherein at least one of the chambers comprises thermal transfer surfaces to increase the surface area thereof,
wherein the pistons, or elements connected therewith, are connected to actuating elements for defining motion profiles for each of the pistons, wherein the actuating elements are designed to define at least two different motion profiles of the pistons of the chamber arrangement,
wherein the chamber arrangement comprises three chambers, wherein a middle one of the three chambers is connected by the at least one connecting duct to the two chambers having different capacities and working temperatures and has a larger capacity than that of the two chambers having a relatively high working temperature,
wherein due to its shape the middle chamber has a larger distance, in terms of the arithmetic mean, between a volume element, which is assumed to be as small as desired, of its partial working volume extended to a reference volume and its inner chamber surface limiting the partial working volume, than at least one of the at least two chambers connected by at least one connecting duct, wherein the reference volume is constituted by the smaller volume of the two maximum partial working volumes obtained during operation by the chambers compared to one another, and the inner chamber surface limiting the partial working volume, of course, also comprises the possible thermal transfer surfaces to increase the surface of the chamber, and comprises the surface areas adjacent the partial working volume of the piston arranged in the chamber, and wherein the distance is defined to be the length of the shortest connecting line.

39. The piston machine according to claim 38, wherein at least one of the actuating elements comprises a motor-generator unit and the piston(s) allocated to the actuating elements or elements connected thereto is/are connected to the rotor of the motor-generator unit.

40. The piston machine according to claim 38, wherein a gear transmission, in particular a pantograph-like coupled gear, or a ball screw is interconnected between at least one of the actuating elements and the piston allocated thereto.

41. The piston machine according to claim 38, wherein due to its shape the middle chamber has an at least 1.5 times larger distance in terms of the arithmetic mean, between a volume element, which is assumed to be as small as desired, of its partial working volume extended to the reference volume and its inner chamber surface limiting the partial working volume than at least one of the at least two chambers connected by at least one connecting duct.

42. The piston machine according to claim 38, wherein at least one of the pistons is connected to a spring element, in particular a magnetic, mechanic or gaseous spring element to support the actuating element allocated to the piston.
